(19) United States
(12) Patent Application Publication
(10) Pub. No.: US 2017/0096874 A1
(43) Pub. Date: Apr. 6, 2017

(54) METHODS OF DESIGNING CEMENTING OPERATIONS AND PREDICTING STRESS, DEFORMATION, AND FAILURE OF A WELL CEMENT SHEATH

(71) Applicant: SCHLUMBERGER TECHNOLOGY CORPORATION, Sugar Land, TX (US)

(72) Inventors: Ethan PARSONS, Somerville, MA (US); Jeffrey J. THOMAS, Winchester, MA (US)

(73) Assignee: SCHLUMBERGER TECHNOLOGY CORPORATION, Sugar Land, TX (US)

(21) Appl. No.: 15/128,002

(22) PCT Filed: Mar. 20, 2015
(86) PCT No.: PCT/US15/21829

§ 371 Date: Sep. 21, 2016

Related U.S. Application Data
(60) Provisional application No. 61/968,719, filed on Mar. 21, 2014.

(51) Int. Cl. E21B 33/14; E21B 47/00; C09K 8/46; G06F 17/11; C04B 28/04; E21B 33/138; G06F 17/50

(52) U.S. Cl. CPC E21B 33/14; E21B 33/138; E21B 47/0005; G06F 17/5009; G06F 17/11; C04B 28/04; C09K 8/46; E21B 47/06

(57) ABSTRACT

Methods of designing a cementing operation for a cement body within a wellbore are described herein. One such method includes determining a stress for the cement body within the wellbore by simulating hydration of the cement body using cementing operation parameters and wellbore conditions. The hydration simulation includes calculating pore pressure for the cement body and accounting for changes in pore pressure associated with chemical shrinkage of the cement body. The method further includes designing a cementing operation using the stress for the cement body and the cementing operation parameters.

### CROSS-REFERENCE TO RELATED APPLICATIONS

This application claims priority to U.S. Provisional Application No. 61/968719, filed Mar. 21, 2014, which is incorporated herein by reference in its entirety.

### BACKGROUND

In oilfield applications, completions operations are conducted after drilling of a wellbore has been completed. During completions, a wellbore may be cased with a number of lengths of pipe in order to stabilize and enhance structural integrity of the wellbore. After placement, the casing may be secured to the surrounding earthen formation by primary cementing operations in which a cement slurry is pumped into an annulus between the casing and the surrounding formation. The cement slurry may then be allowed to solidify in the annular space, thereby forming a sheath of cement that retains the casing in position and prevents the migration of fluid between zones or formations previously penetrated by the wellbore.

During completions operations, a robust cementing job supports and protects production casing and prevents unwanted vertical movement of fluids and gases. Well-cement sheaths may encounter at least three possible failure modes: (i) shear failure due to excessive compressive stresses; (ii) radial or axial cracking due to excessive tensile stresses in the hoop (circumferential) direction; and (iii) debonding from the casing or the formation. Further details regarding stress conditions are provided in U.S. Pat. No. 6,296,057 issued on Oct. 2, 2001, which is incorporated by reference herein in its entirety. Determining the appropriate type and amount of cement, as well as the waiting time before operations may begin after placement, may involve a number of variables including the variation in chemical properties of the cement and stresses induced through physical stresses as the cement cures.

### SUMMARY

Various embodiments of the present disclosure are directed to a method of designing a cementing operation for a cement body within a wellbore. The methods includes determining a stress for the cement body within the wellbore by simulating hydration of the cement body using cementing operation parameters and wellbore conditions. The hydration simulation includes calculating pore pressure for the cement body and accounting for changes in pore pressure associated with chemical shrinkage of the cement body. The method further includes designing a cementing operation using the stress for the cement body and the cementing operation parameters.

Illustrative embodiments of the present disclosure are directed to a processing system for designing a cementing operation for a cement body within a wellbore. The system includes a processor and a memory storing instructions executable by the processor to perform processes that include: (i) determine a stress for the cement body within the wellbore by simulating hydration of the cement body using cementing operation parameters and wellbore conditions, where the simulating hydration of the cement body includes calculating pore pressure for the cement body and accounting for changes in pore pressure associated with chemical shrinkage of the cement body; and (ii) design a cementing operation using the stress for the cement body and the cementing operation parameters.

In another aspect, various embodiments disclosed herein are directed to a method of performing a cementing operation for a cement sheath emplaced between casing and a formation within a wellbore. The method includes determining a stress for the cement sheath within the wellbore by simulating hydration of the cement sheath from a time of placement to a time of set using cementing operation parameters and wellbore conditions. The hydration simulation includes calculating pore pressure for the cement sheath and accounting for changes in pore pressure associated with chemical shrinkage of the cement sheath. The method further includes designing a cementing operation using the stress for the cement sheath and the cementing operation parameters. Then, the cementing operation is performed.

Other aspects and advantages of the present disclosure will be apparent from the following description and the appended claims.

### BRIEF DESCRIPTION OF THE DRAWINGS

The subject disclosure is further described in the detailed description that follows, in reference to the noted drawings by way of non-limiting examples of the subject disclosure, in which like reference numerals represent similar parts throughout the several views of the drawings.

FIGS. 1.1 and 1.2 are illustrations of a completions and cementing operation in which cement is installed in an annular region created between a borehole and an installed casing.

FIGS. 2.1-2.3 are illustrations of a cross section of a cemented casing demonstrating various stress and failure modes that may be encountered in a cased and cemented wellbore.

FIGS. 3.1-3.2 are illustrations showing the changes of stress T, pore pressure p, and temperature θ on a cement slurry placed into a wellbore between the time of placement and time of set, and describe the complexity of calculating the state of stress at time of set.

FIG. 4 is a flow chart in accordance with various embodiments of the present disclosure.

FIG. 5 is an illustration showing a mass balance equation for free water in hydrating cement in accordance with various embodiments of the present disclosure.

FIG. 6 is an illustration showing two levels of resolution at which homogenized properties of a hydrating cement paste may be calculated in accordance with various embodiments of the present disclosure.

FIG. 7 is a graphical representation of a hydration function that characterizes the volume fractions of various phases of cement paste for a class G Portland cement in accordance with various embodiments of the present disclosure.

FIG. 8 is a graphical representation showing predictions of the macroscopic Young's modulus, Ē(ξ), at w/c=0.42, as a function of time in accordance with various embodiments of the present disclosure.

FIG. 9 is a graphical representation showing predictions of Young's modulus, Ē(ξ), at a water to cement ratio (w/c) of 0.4, as a function of the degree of hydration in accordance with various embodiments of the present disclosure.

FIG. 10 is a graphical representation showing predictions of shear modulus, G̅(ξ), at w/c=0.4, as a function of the degree of hydration in accordance with various embodiments of the present disclosure.

FIG. 11 is a graphical representation of cement permeability as a function of the degree of hydration in accordance with various embodiments of the present disclosure.

FIG. 12 is a graphical representation showing model prediction versus experimental results for a chemical shrinkage experiment at θ=25° C. for w/c=0.42 in accordance with various embodiments of the present disclosure.

FIG. 13.1 is an illustration of an experimental set-up for a sealed hydration experiment in accordance with various embodiments of the present disclosure.

FIG. 13.2 is a graphical representation showing model prediction versus experimental results for a sealed hydration experiment at θ=21° C. for w/c=0.5 in accordance with various embodiments of the present disclosure.

FIG. 14.1 is a graphical representation of the pore pressure in a ultrasonic cement analyzer (UCA) experiment at θ=40° C. for w/c=0.45 in accordance with various embodiments of the present disclosure.

FIG. 14.2 is a graphical representation comparing a model prediction with experimental results for a sum of pressure drops in a UCA experiment in accordance with various embodiments of the present disclosure;

FIGS. 15.1-15.3 are illustrations showing a sequence of loadings in a finite element simulation of a hydrating cement sheath in accordance with various embodiments of the present disclosure.

FIG. 16.1 is an illustration showing a model prediction of pore pressure at an inner radius and an outer radius of a cement sheath after 48 hours of hydration for cement placed against a soft formation in accordance with various embodiments of the present disclosure.

FIG. 16.2 is an illustration showing a model prediction of pore pressure at an inner radius and an outer radius of a cement sheath after 48 hours of hydration for a cement placed against a stiff formation in accordance with various embodiments of the present disclosure.

FIG. 17.1 is a graphical representation of a model prediction of hoop stress at an inner radius and an outer radius of a cement sheath after 48 hours of hydration for cement placed against a soft formation, in accordance with various embodiments of the present disclosure.

FIG. 17.2 is a graphical representation of hoop stress at an inner radius and an outer radius of a cement sheath after 48 hours of hydration for a cement placed against a stiff formation, in accordance with various embodiments of the present disclosure;

FIG. 18.1 is a graphical representation showing the effective hoop stress in a cement sheath after increase of casing pressure of 40 MPa for a cement placed against a soft formation (G^{form}=2 GPa) in accordance with various embodiments of the present disclosure; and

FIG. 18.2 shows effective hoop stress in the cement sheath after increase of casing pressure of 40 MPa for cement placed against a stiff formation (G^{form}=20 GPa) in accordance with various embodiments of the present disclosure.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

Embodiments disclosed herein are directed to methods of designing cementing treatments suitable for use in wellbore cementing applications. In some embodiments, methods may include using various modeling techniques to calculate physical stresses in a setting cement to aid in the formulation and design of a cement job that is tailored to the particular application and conditions present downhole. For example, modeling stress encountered by a cement sheath may provide guidelines as to how a cement composition will perform, and what changes should be made, if any, to the cement composition to ensure adequate performance. In some embodiments, modeling results may indicate that stress in the cement sheath exceeds a measured or known failure criteria and therefore is likely to fail (e.g., fracture, fail in shear, or develop a microannulus). Then, the cement composition may be modified by providing a cement additive or other structural modifiers to increase the durability of the final cement sheath so that it is below the failure criteria and less likely to fail.

Following the drilling of a wellbore, completions operations may involve placing a pipe string or casing to line the well. Well casings of various sizes may be used, depending upon depth, desired hole size, and geological formations encountered. The casing may serve several functions, including providing structural support to the wellbore to prevent the formation walls from caving into the wellbore. The casing may, in some instances, be stabilized and bonded in position within the wellbore by displacing a portion of the drilling fluid during a primary cementing operation in which a cement slurry is used to set the casings in place.

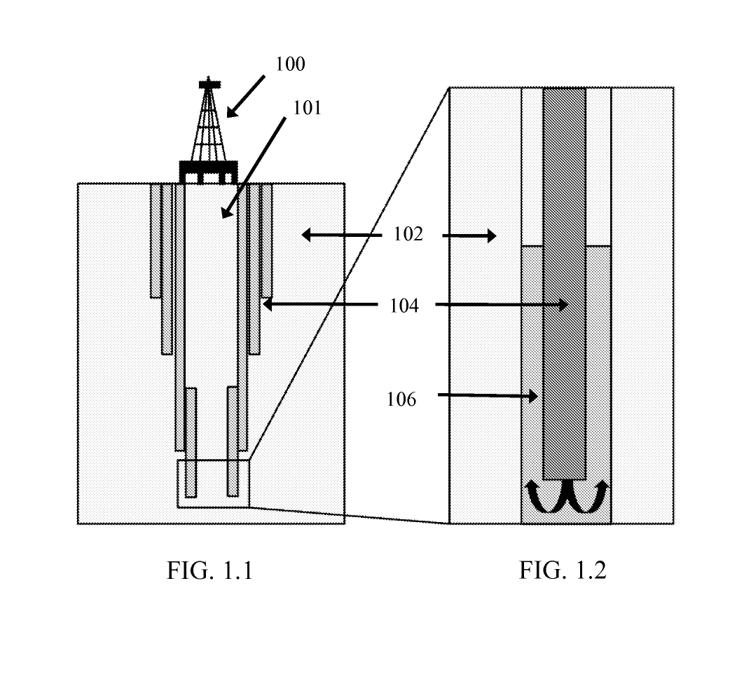

With particular respect to FIG. 1.1, a derrick 100 is shown installed on a wellbore 101 traversing a formation 102. Within the wellbore 101 concentric segments of casing 104 are nested within each other, in preparation for installation of a cement sheath between the outside of the casing and the exposed formation and/or other emplaced casing strings. With particular respect to FIG. 1.2, a cementing operation is conducted in which a cement slurry 106 is pumped into an annulus formed between formation 102 and the casing 104. In some embodiments, cement slurry may be pumped into multiple annular regions within a wellbore such as, for example, (1) between a wellbore wall and one or more casing strings of pipe extending into a wellbore, or (2) between adjacent, concentric strings of pipe extending into a wellbore, or (3) in one or more of an A- or B-annulus (or greater number of annuli where present) created between one or more inner strings of pipe extending into a wellbore, which may be running in parallel or nominally in parallel with each other and may or may not be concentric or nominally concentric with the outer casing string.

Cement Hydration

A feature that distinguishes cements from most other structural materials is that cements undergo various chemical changes during hydration and curing that may result in the formation of distinct phases of solid cement and cement slurry during normal use. Other changes that occur during cement hydration include volume changes due to chemical shrinkage in which the volume of water decreases as it is bound into cement hydration products.

Cement begins as a powder obtained by grinding a cement clinker manufactured by firing mixtures of limestone and clay, which contains aluminate and ferrite impurities. For many cement compositions, cement clinker is then mixed with gypsum (calcium sulfate dihydrate), which is added to moderate the hydration process. After grinding together the clinker and gypsum, the cement powder is composed of multi-size, multi-phase, irregularly shaped particles that may range in size from less than a micron to tens or hundreds of microns.

When the cement is mixed with an aqueous fluid, hydration reactions occur that convert the water-cement suspension into a rigid porous material that serves as the matrix phase for mortar and cement. The nominal point of hydration at which this conversion to a solid framework occurs is called the set point. The degree of hydration (represented as ξ) at any time is the volume fraction of the cement that has hydrated (reacted with water). The ratio of water to cement (w/c) in a given mixture is defined as the mass of water used divided by the mass of cement used.

Early-age cement experiences several physical and chemical changes during its hydration process, including changes in temperature due to exothermic hydration reactions, a decrease in total porosity, and pore pressure changes associated with changing pore sizes as the cement sets. Furthermore, because cement hydration products are denser than the constituent reactants from which they form, there is an internal volume reduction associated with the reaction between cement and water in hydrating cement paste. This internal volume reduction associated with the reaction between cement and water in hydrating cement paste is referred to herein as “chemical shrinkage.” The physical and chemical changes inside the curing cement can cause pore pressure changes, deformation, induced stresses, and lead to premature failure of the cement sheath depending on the surrounding environment.

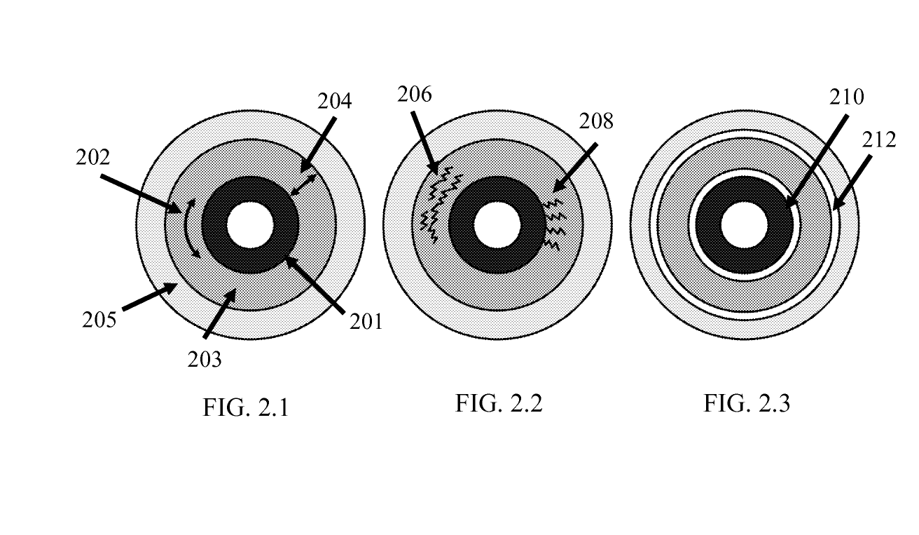

With particular respect to FIGS. 2.1-2.3, a number of the various stress and failure modes are shown that may be encountered in a cased and cemented wellbore. In FIG. 2.1, a cross section of a cased wellbore and a surrounding cement sheath traversing a formation is shown. A wellbore casing 201 is emplaced within a wellbore in formation 205 and a cement slurry is injected into the annulus created between the formation 205 and casing 201, which hardens into cement sheath 203. As the cement sheath forms, stresses present in the sheath downhole may take the form of radial stresses, shown as double-ended arrow 204, tangential stresses, shown as double-ended arrow 202, axial stresses (e.g., compressive stresses or tensile stresses), which are in and out of the page in FIGS. 2.1-2.3, or combinations of these stresses. Tangential stresses are also referred to as hoop stresses.

Depending on the structural properties of the cement sheath, as downhole stress conditions change, such as in response to temperature and pressure changes, a cement job may fail. For example and with particular respect to FIG. 2.2, large increases in wellbore pressure or temperature and tectonic stresses may cause cracks to form in the sheath and cause shear failure 206 or cracks caused by tensile stresses 208. Further, bulk shrinkage of the cement or pressure and temperature variations of fluids within the casing or the hydrating cement may cause debonding of the cement sheath from the formation 205 or casing 201. In some instances, debonding may result in a cement job failure in which microannuli form between one or more of the casing and cement sheath 210 or between the cement sheath and the formation 212 as shown in FIG. 2.3. Other causes of cement failure may include testing methods such as hydraulic pressure testing—a common test of zonal isolation—in which internal pressure is applied along the entire casing string. During testing, pressure may expand the casing, causing the cement sheath to experience tensile failure, which may lead to radial cracks and local debonding of the cement and casing in areas where the cracks are near the casing wall. Pressure changes may also occur in subsequent operations such as fracturing, enhanced oil recovery, steam injection, and other high-pressure wellbore stimulation techniques.

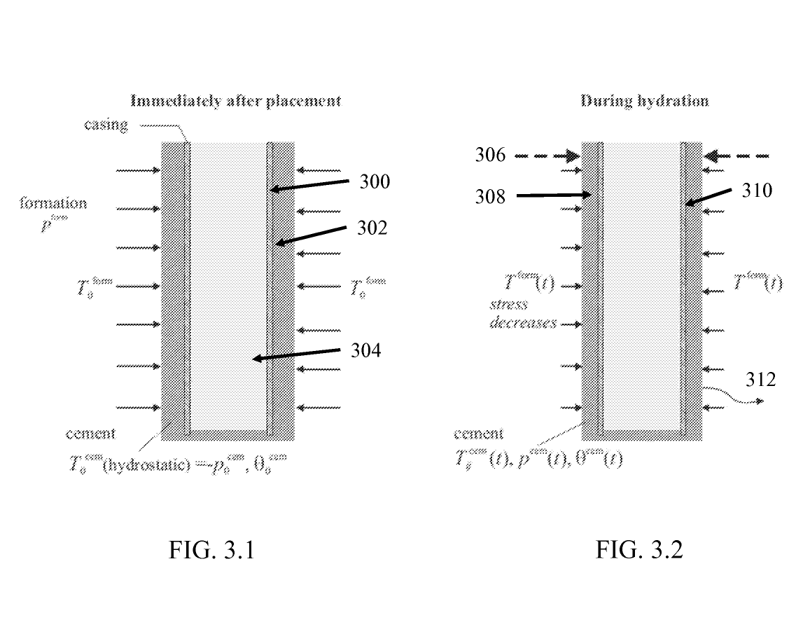

With particular respect to FIGS. 3.1 and 3.2, a cement may be pumped down through the casing 300 during completions operations and other cement injection techniques, and then displaced by a wellbore fluid 304 through the annulus as a viscoelastic slurry 302. The pressure downhole may reach tens of MPa and temperature may reach up to about 250° C. in some formations. With particular respect to FIG. 3.1, formation stresses Tₒ, attributed in part to pore pressure of the formation p^{form}, counter the hydrostatic force of the injected cement slurry 302. While the cement is still a liquid, the hydrostatic stress and pore pressure at a given depth are both equal to the weight of the fluid column in the wellbore. Because this stress or pore pressure may be greater than the formation pore pressure, water may flow out of the cement and into the formation, causing the top of the cement column to move down.

FIG. 3.2 shows a cement sheath 308, casing 310, the formation 306, and a direction of fluid loss 312. After an amount of time—that depends on the nature of the cement composition—the cement sheath undergoes some measure of bulk shrinkage as hydration products of the cement percolate and the slurry transitions into a porous solid.

The matrix of this newly formed cement sheath resists axial movement, and the shrinkage of the cement is no longer converted entirely into axial deformation. As a result of fluid loss into the formation and chemical shrinkage, the pore pressure originally attributable to the self-weight of the cement slurry decreases. This decrease in pore pressure of the cement results in radial consolidation and deformation of the cement, which in turn causes the stress that the formation places on the sheath, T^{form}(t), to decrease and the total stress in the cement to decrease. Further deformation may be caused by thermal expansion and/or contraction resulting from heat generated from the hydration reaction and the conduction of heat from the formation to the casing. At the same time, the cement rapidly gains stiffness and loses permeability as the hydration reaction proceeds.

In one or more embodiments, methods in accordance with the present disclosure may provide a prediction of stresses that are experienced within a curing body of cement to enable an operator to optimize conditions and setting of cement to minimize the risk of failure. In some embodiments, models may be developed that permit an operator to design a cementing operation based on the demands of a given wellbore conditions by modifying cement set times or structural properties using model outputs.

Cementing Operation Design Process

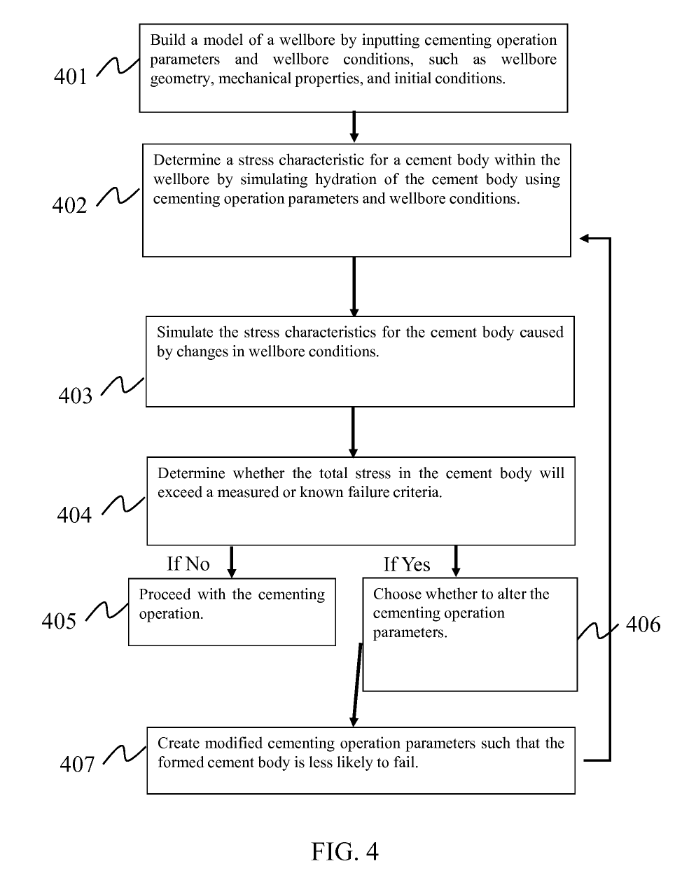

In one or more embodiments, methods of the present disclosure may be directed to the design of cementing operations based on cementing operation parameters and the conditions of the wellbore. The cementing operations can be used to form a cement body within the wellbore, such as a cement sheath, as described in FIGS. 1.1 and 1.2, or a cement plug. With particular respect to FIG. 4, a flow chart depicting various embodiments of the present disclosure is provided.

As shown in the flow chart, the method involves inputting wellbore conditions (at 401). The wellbore conditions may include (i) mechanical properties of the formation, (ii) temperature of the formation, (iii) pore pressure of the formation, (iv) depth within the wellbore, (v) dimensions of the wellbore, (vi) wellbore geometry, (vii) weight of a fluid column above the cement body, and (viii) fluid pressure in the casing.

The method also includes inputting cementing operation parameters (at 401). The cementing operation parameters may include: (i) cement composition (e.g., water to cement ratio, mass fractions of the cement components, and/or volume fractions of the cement components, such as clinker components and C-S-H particles), (ii) mechanical properties of cement components (e.g., elastic moduli of clinker components and elastic moduli of C-S-H particles), (iii) casing dimensions, (iv) mechanical properties of the casing, and (iv) number of stages in the cementing operation (e.g., to reduce the length of individual stages). Further cementing operation parameters and wellbore conditions are shown in Tables 1 and 2 below.

A model of the wellbore and the cement body can be constructed using some or all of these cementing operation parameters and wellbore conditions. The method further includes simulating stress for the cement body caused by hydration of the cement (at 402) and simulating stress for the cement body caused by changes in wellbore conditions due to well operations or changes in formation stress (at 403). The hydration simulation at 402 may include calculating pore pressure for the cement body and accounting for changes in pore pressure caused by chemical shrinkage of the cement body. The stress for the cement body caused by changes in wellbore conditions (determined at 403) is added to an initial state of stress for the cement body (determined at 402) to determine the total stress. Then, the method determines whether the total stress in the cement will cause the cement body to fail (at 404).

At this point, if the total stress in the cement body is below a failure criteria of the cement, the cementing operation may proceed (at 405). The failure criteria may be a set of known values or the criteria can be experimentally determined. For example, failure experiments can be performed on particular cement compositions to measure the failure criteria. The failure criteria may include tensile strength for cracking, Mohr-Coulomb failure criterion for shear failure, and/or bond strength for debonding from casing and/or formation (e.g., microannulus formation). If it is determined that the stresses in the cement body will cause the body to fail given the selected cementing operation parameters, the operator may choose to alter the cementing operation parameters such that the formed cement body does not fail or is less likely to fail (at 406). In some embodiments, modified cementing operation parameters (e.g., modified cement composition, casing dimensions, and/or well operations) may be designed, such as by changing the type of cement, adding a hydration retarder or accelerant, adding a structural modifier (at 407). Once the modified cementing operation parameters are selected, the cementing operation may proceed or, if desired, the cementing operation parameters may be tested using the model created and repeating 402-404 to verify that the modified cementing operation parameters are below the failure criteria.

The following sections will outline individual aspects of methods in accordance with the present disclosure.

Determination of Cementing Operation Parameters

In one or more embodiments, methods in accordance with the present disclosure may include a model of a wellbore that includes inputs of various physical parameters of a potential cementing operation. In some embodiments, parameters may include geometric measurements of the cased wellbore such as the diameter and thickness of the casing and the open hole diameter; mechanical properties such as the elastic constants of the casing material and the shear modulus of the formation; and chemical properties of the cement composition such as the mass fractions of the constituent phases of the cement and the permeability of the cement. Additional wellbore parameters that may be considered include wellbore conditions such as the total vertical depth of the wellbore, the formation permeability and initial pore pressure, wellbore temperature, and other indicia of stresses on a formed cement body such as the height and density of the fluid column above the cement slurry or set cement body.

Simulating Cement Hydration using Macroscopic Poroelastic Relationships

In one or more embodiments, methods in accordance with the present disclosure may include simulating the hydration of a cement slurry to form a cured cement body. The hydration of cement is a dynamic chemical process, and chemical shrinkage and fluid transfer to or from the formation may induce a change in the pore pressure of the cement, which may, in turn, cause deformation and stress on the formed cement. The stress caused by hydration of the cement and exchange of fluid with the formation acts as an initial state of stress, to which increments of stress caused by changes in wellbore conditions are added.

This initial state of stress within the newly set cement determines how close the cement is to failure before the cement body is subjected to additional loads imposed by changes in wellbore conditions. Considering the large hydrostatic compressive stresses present at large depths at the time of cement placement, when the cement is in liquid form, in many cases, there may be a sizable compressive stress remaining at the time of set, which may protect against radial fracture and debonding in some cases. In one or more embodiments, methods in accordance with the present disclosure incorporate nonlinear models that account for the changing properties of a curing cement based on known properties of constituents of cement, including hydraulic cements such as Portland cement. In some embodiments, methods may calculate the state of stress in the cement at the time of set and prior to the initiation of further wellbore operations such as a pressure test or fluid swap. For example, methods may simulate hydration of a cement body, including calculating pore pressure for the cement body and accounting for changes in pore pressure associated with chemical shrinkage of the cement body.

In some embodiments, methods may include determining volume fractions for a number of phases within the cement body as a function of degree of hydration. The volume fractions may include the volume fraction of unreacted water (or free water), the volume fraction of clinker, the volume fraction of hydration product, and/or the volume fraction of chemical shrinkage of the cement paste. Methods may also include a determination of a number of poroelastic properties for the cement body as a function of degree of hydration using the volume fractions for the phases in some embodiments.

Cement paste, or cement slurry, is a mixture of water and unhydrated cement clinker. Cement paste is a multi-phase material in which the volume fraction of each phase varies as a function of time. Once mixed, a chemical reaction occurs between the cement grains and water causes calcium-silicate-hydrate (C-S-H), a substantial contributor to the total hydration product, to form on the surface of the cement particles. The solid C-S-H particles are nanoscale in size and are assumed to possess a layered, porous sheet structure with water physically adsorbed to each sheet. Other hydration products form as well, typically in lower amounts.

The structure of a hydrating cement grain may be subdivided on the basis of pore size of the structure and level of water contained within. In regions having very small pores (leas than 2.5 nm), water trapped in the pores is considered to be non-evaporable and part of the C-S-H solid. In other regions having porosity on the scale of about 2.5 to 30 nm, also termed “gel porosity,” intra-granular water can exist within the hydration product. The remaining unreacted water in the cement paste exists in pores larger than 30 nm, which are termed “capillary pores.”

The extent of the completion of the hydration reaction for a given cement is described by the degree of hydration (ξ) as shown in Equation 1:

$$ξ ≡ 1 - \frac{{m}^{cem}}{{m}_{0}^{cem}} \qquad ( 1 )$$

where m^{cem} is the mass of unhydrated cement in the paste after some period of time and m₀^{cem} is the initial mass of unhydrated cement. When the initial water to cement ratio (w/c) may be less than about 0.45 in some embodiments, the water in the capillary pores will be eventually converted into non-evaporable or gel pore water.

At a fixed degree of hydration, the elastic deformation of cement can be modeled by the Biot Poroelastic theory, which describes the linked interaction between fluids and deformation in porous media. For a hydrating cement, the components of the macroscopic stress in the cement Tᵢⱼ are a function of the components of the small strain tensor E, the volumetric strain Eᵥ, and the pore pressure p as shown in Equation 2:

(Tᵢⱼ)_{ξ}=2G̅(ξ)Eᵢⱼ+[K̅(ξ)−2/3G̅(ξ)]Eᵥδᵢⱼ−α̅(ξ)pδᵢⱼ(i=1,3; j=1,3) (2)

where K̅(ξ) is the macroscopic drained bulk modulus at the current degree of hydration, G̅(ξ) is the drained shear modulus at the current degree of hydration, and α̅(ξ) is the macroscopic Biot-Willis coefficient.

Material parameters and porosity defined at the macroscopic level of the cement paste are indicated with an overline. G̅ and K̅ are referred to as “drained” moduli because they are the moduli that are measured under conditions of constant pore pressure, dp=0. The change in macroscopic porosity of the cement is given by Equation 3:

$${( \overline{φ} - {\overline{φ}}_{0} )}_{ξ} = \overline{α} ( ξ ) {E}_{v} + \frac{p}{\overline{N} ( ξ )} \qquad ( 3 )$$

where N̅(ξ) is the macroscopic Biot tangent modulus. In poroelastic theory, the porosity of the material is connected. Therefore, the macroscopic porosity of the cement can be considered to include both the capillary porosity and the gel porosity. Furthermore, because fluid loss and/or injection occur slowly in a downhole cement sheath, the pore pressure in the gel pores can be considered equal to the pore pressure in the capillary pores.

As the cement hydrates, the poroelastic properties evolve because the volume fractions of each phase of the cement vary over time. Changes in volume fractions of the phases within the cement in turn causes variations in strain and pore pressure that occur on a time scale that corresponds to the kinetics of the hydration reaction. Therefore, Equations 2 and 3 may be linearized in order to calculate the change in macroscopic stress and macroscopic porosity over a time increment during which the degree of hydration is approximately constant (e.g., on the order of minutes). The increment of macroscopic stress then becomes a function of the increments of strain and pore pressure as shown in Equation 4.

dTᵢⱼ=2G̅(ξ)dEᵢⱼ+[K̅(ξ)−2/3G̅(ξ)]dEᵥδᵢⱼ−α̅(ξ)dpδᵢⱼ (4)

In one or more embodiments, sources of macroscopic stress may include changes in casing pressure from wellbore operations; radial, tensile, and axial stresses generated from the hydrating cement composition; and axial stress generated from the weight of a fluid column above a hydrating cement composition.

The increment of porosity for the cement hydration follows similarly, but an additional porosity term is included in order to capture the change in porosity of the cement caused by the chemical reaction alone. The total increment in porosity is the sum of the poroelastic porosity change (ξ is constant) and the chemical porosity change (E, p are constant) as shown in Equation 5:

$$d \overline{φ} = {( d \overline{φ} )}_{ξ} + {( d \overline{φ} )}_{{E}_{v} , p} = \overline{α} ( ξ ) {dE}_{v} + \frac{dp}{\overline{N} ( ξ )} + d {\overline{φ}}_{ch} \qquad ( 5 )$$

where dφ̅_{ch} describes the decrease in the sum of the capillary porosity and the gel porosity at the macroscopic level caused by the growth of the hydration product.

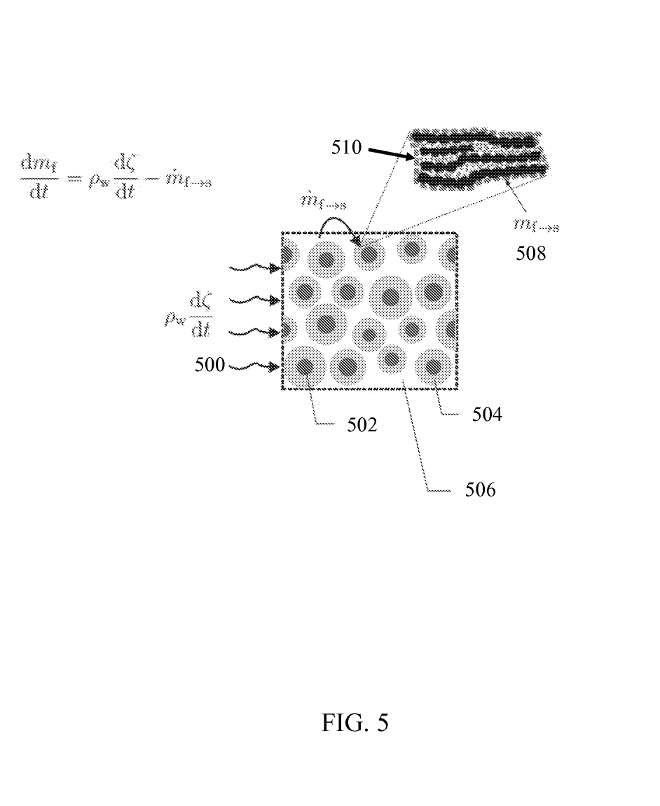

With particular respect to FIG. 5, a schematic representation of a hydrating cement is shown. As free water 500 contacts the cement clinker particles 502, the hydration product 504 begins to precipitate on the surface of the clinker particles. Water is then partitioned into distinct phases of the hydrating cement, with capillary pore water 506 occupying the free space between the hydrating clinker particles, and structural water 508 becoming entrained in the nanopores created within the pore structure of the hydration product 510.

The mass balance equation defines the rate of change of free water, m_{f}, in the cement paste. From the mass balance equation and the equation of state for the free water in a cement paste, Equation 5 may be rewritten to solve for the increment in total fluid content dζ as shown in Equation 6:

$$d ζ = \overline{α} ( ξ ) {dE}_{v} + ( \frac{1}{\overline{N} ( ξ )} + \frac{\overline{φ} ( ξ )}{{k}_{w}} ) dp + ( \frac{{\dot{m}}_{f -> s} dt}{{ρ}_{w}} + d {\overline{φ}}_{ch} ) \qquad ( 6 )$$

where k_{w} is the bulk modulus of water, ρ_{w} is the density of capillary pore water, and \dot{m}_{f→s} is the rate per unit reference volume of cement paste at which capillary water is converted to non-evaporable water. Here, the water is designated as a solid using the subscript “s” because the water is entrained within the solid mass of the cement hydrated and no longer in fluid contact with the remaining water in the capillary pores and gel pores.

The sum of the last two terms in Equation 6 is a positive quantity that typically causes the increment in fluid content to increase under drained conditions (dp=0) and causes the pore pressure to decrease under sealed conditions (dξ=0). This expression exists because of the chemical shrinkage of the cement in which the hydration product of cement is denser than the weighted average densities of the reactants.

Microporomechanics of Hydrating Cement Paste

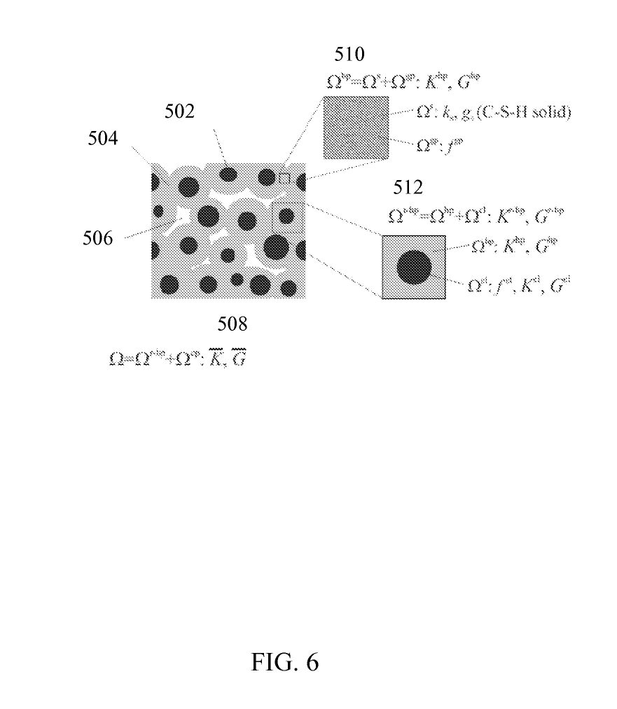

The technique of microporomechanics is used to determine the macroscopic poroelastic properties of the cement paste as a function of the degree of hydration by quantifying the properties and volume fraction of each constituent phase. For example, the cement paste can be conceptualized as a multiscale and three-level composite with porosity at two different scales: gel porosity and capillary porosity. In this approach, each level contains two phases, and the homogenized properties at one level become the properties of a single phase at the next level. With particular respect to FIG. 6, a schematic is shown that illustrates the differing phases within a hydrating cement. As the cement hydrates, clinker particles 502 are coated with hydration product 504. At the macroscopic level 508, the hydrating cement particles then begin to form a matrix having an interconnected network of capillary pores 506. However, the phases of the hydrating cement paste may also be subdivided into microscopic regions containing only hydration product, denoted “Level I,” and regions of reinforced hydration product 512 having a nucleus of cement clinker, denoted “Level II.”

At Level I the hydration product is composed of gel pores and C-S-H solid particles, with increments of local stress as defined by Equation 7:

dσᵢⱼ^{I}=2G^{hp}dεᵢⱼ^{I}+(K^{hp}−2/3G^{hp})dεᵥ^{I}δᵢⱼ−b^{hp}dp (7)

and local porosity given by Equation 8:

$$d {φ}^{I} ≡ {df}^{ gp} = {α}^{hp} d {ɛ}_{v}^{ I} + \frac{dp}{{N}^{gp}} \qquad ( 8 )$$

where the poroelastic properties are not a function of the current degree of hydration. At Level I in FIG. 6 (510), Ω^{hp} is the volume of hydration product, Ω^{gp} is the volume of gel pores, Ω^{s} is the volume of C-S-H solid particles. At Level II (512), stiff and bonded clinker inclusions are added to a matrix of hydration product (the Level I material) to form reinforced hydration product (“r-hp”). At Level II in FIG. 6 (512), Ω^{hp} is the volume of reinforced hydration product and Ω^{cl} is the volume of the cement clinker components.

The increments of local stress and local porosity at this level can be written as:

$$\begin{matrix}d {σ}_{ij}^{II} = 2 {G}^{r - hp} ( ξ ) d {ɛ}_{ij}^{II} + [ {K}^{r - hp} ( ξ ) - \frac{2}{3} {G}^{r - hp} ( ξ ) ] d {ɛ}_{v}^{II} {δ}_{ij} - {α}^{r - hp} ( ξ ) dp \\ and & ( 9 ) \\ d {φ}^{II} ≡ ( 1 - {f}^{cl} ) {df}^{ gp} = {α}^{r - hp} ( ξ ) d {ɛ}_{v}^{II} + \frac{dp}{{N}^{r - hp} ( ξ )} & ( 10 )\end{matrix}$$

where the poroelastic properties are a function of the current degree of hydration.

The macroscopic level (the level at which Equations 4-6 are written) adds capillary pores to a matrix of the Level II material to construct the complete cement paste with macroscopic porosity as shown in Equation 11.

φ̅≡f^{cp}(ξ)+[1−ƒ^{cp}(ξ)]φ^{II}(ξ) (11)

At the macroscopic level of FIG. 6 (508), Ω is the total volume of the cement paste and Ω^{cp} is the volume of capillary pores.

In one or more embodiments, methods may also include determining elastic moduli of a cement or cement sheath. For example, methods in accordance with embodiments of the present disclosure may include determining elastic moduli of the cement from one or more properties such as: (i) elastic moduli for a hydration product, (ii) elastic moduli for clinker components, (iii) mass fractions for clinker components, (iv) capillary porosity, and (v) a set of hydration functions that characterize volume fraction for a plurality of phases within the cement.

Well-known composite homogenization schemes may be used to calculate the drained elastic properties at each level described in FIG. 6. At Level I, a self-consistent method may be used to calculate the drained bulk and shear moduli of the hydration product, K^{hp}(ξ) and G^{hp}(ξ), from the moduli of the C-S-H solid particles kₛ and gₛ, and the Level I volume fraction of gel pores ƒ^{gp}. At Level II, a generalized self-consistent method may be used to calculate (i) the drained elastic moduli of the reinforced hydration product K^{r-hp}(ξ) and G^{r-hp}(ξ) from the Level I properties, (ii) the elastic moduli of the bonded clinker K^{cl} and G^{cl}, and (iii) the volume fraction of clinker θ^{cl}(ξ).

At the macroscopic level, the self-consistent method is used once more to calculate the macroscopic drained elastic moduli of the cement paste K̅(ξ) and G̅(ξ) (as they appear in Equation 4) from the Level II properties and the capillary porosity θ^{cp}. The self-consistent scheme percolates at f^{cp}=0.5, and therefore the cement paste can be predicted to percolate at the degree of hydration corresponding to a capillary porosity of θ^{cp}=0.5.

The drained elastic bulk moduli at each level are then used to calculate the remaining poroelastic constants. At Level-I, the Biot-Willis coefficient and the Biot tangent modulus are defined by Equation 12.

$${α}^{hp} = 1 - \frac{{K}^{hp}}{{k}_{s}} and \frac{1}{{N}^{hp}} = \frac{{b}^{hp} - {f}^{hp}}{{k}_{s}} \qquad ( 12 )$$

At Level II, these properties are derived as shown in Equation 13:

$${α}^{r - hp} ( ξ ) = {α}^{hp} \{ 1 - \frac{{K}^{r - hp} ( ξ ) - {K}^{hp}}{{K}^{cl} - {K}^{hp}} \} \qquad ( 13 )$$

### and Equation 14:

$$\frac{1}{{N}^{r - hp} ( ξ )} = {α}^{hp} {\{ {K}^{hp} - {K}^{cl} \}}^{- 1} [ ( 1 - {f}^{cl} ) {α}^{hp} - {α}^{r - hp} ( ξ ) ] + \frac{( 1 - {f}^{cl} )}{{N}^{hp}} . \qquad ( 14 )$$

At the macroscopic level of the cement paste, corresponding to Equations 4-6, the poroelastic properties are calculated as shown in Equation 15:

$$\overline{α} ( ξ ) = 1 + \frac{\overline{K} ( ξ )}{{K}^{r - hp} ( ξ )} ( {α}^{r - hp} ( ξ ) - 1 ) \qquad ( 15 )$$

### and Equation 16:

$$\frac{1}{\overline{N} ( ξ )} = \frac{1}{{K}^{r - hp} ( ξ )} \{ {f}^{cp} - \overline{α} ( ξ ) + ( 1 - {f}^{cp} ) {α}^{r - hp} ( ξ ) \} [ {α}^{r - hp} ( ξ ) - 1 ] + \frac{1 - {f}^{cp}}{{N}^{r - hp} ( ξ )} . \qquad ( 16 )$$

The preceding equations are general and could be used to model any cement paste for a given w/c ratio.

The remaining inputs are: (i) the elastic moduli of the clinker grains and the C-S-H particles; and (ii) the volume fraction of each phase as a function of the degree of hydration. The elastic moduli of the C-S-H particles and the clinker particles have been well characterized by numerous nanoindentation studies. Typical results are kₛ=40.5 GPa and gₛ=24.3 GPa and K^{cl}=105.2 GPa and G^{d}=4.8 GPa. The method to determine the volume fraction of each phase of the cement paste is described in the following section.

Determining the Volume Fractions of Phases of a Hydrating Cement Paste

In one or more embodiments, the volume fraction of each phase in a hydrating cement paste can be predicted from the initial composition of the cement through experimental determinations of water content and specific volume of the various cement phases determined for specific initial cement compositions. The total volume of a cement paste hydrating with access to water remains approximately constant during the hydration process described by Equation 17:

V^{tot}(ξ)=V^{W}(ξ)+V^{cl}(ξ)+V^{hp}(ξ)+V^{sh}(ξ)≈1 (17)

where at the macroscopic level, V^{W} (ξ) is the volume fraction of unreacted water or free water excluding any water added to the cement paste, V^{cl}( ξ) is the volume fraction of clinker, V^{hp} ( )is the volume fraction of hydration product, and V^{sh} (ξ) is the volume fraction of chemical shrinkage of the cement paste. Chemical shrinkage occurs because the hydration products occupy a smaller volume than the unreacted components, and chemical shrinkage is manifested predominantly in the form of internal shrinkage and not a bulk volume change.

Under saturated conditions and initially high pore pressures, such as in a cement sheath downhole, the volume fraction of chemical shrinkage is primarily converted to capillary water porosity. Therefore, the volume fraction of capillary pores can be defined as shown in Equation 18.

ƒ^{cp}(ξ)≡V^{W}(ξ)+V^{sh}(ξ) (18)

Hydration functions can be derived to characterize the macroscopic volume fraction of each phase in the cement paste as a function of the initial water to cement ratio (w/c).

In one or more embodiments, the set of hydration functions may include (i) a hydration function for volume fraction of unreacted water, (ii) a hydration function for volume fraction of clinker components, (iii) a hydration function for volume fraction of hydration product, and (iv) a hydration function for volume fraction of chemical shrinkage. In some embodiments, the volume fractions be calculated using the hydration functions of Equations 19-22 from the current degree of hydration of the cement.

free water:

$${V}^{w} = {n}_{0} ( 1 - \frac{{w}^{r}}{w / c} ) ξ \qquad ( 19 )$$

clinker:

$${V}^{c l} = \frac{{n}_{0}}{w / c} ( 1 - ξ ) \frac{{v}^{cl}}{{v}^{w}} \qquad ( 20 )$$

hydration product:

$${V}^{h p} = \frac{{n}_{0}}{w / c} ( \frac{{v}^{cl}}{{v}^{w}} + {w}^{r} \frac{{v}^{r}}{{v}^{w}} ) ξ \qquad ( 21 )$$

chemical shrinkage:

$${V}^{sh} = \frac{{n}_{0}}{w / c} {w}^{r} ( 1 - \frac{{v}^{r}}{{v}^{w}} ) ξ \qquad ( 22 )$$

In the Equations 19-22, n₀ is the initial volume fraction of water, w^{r}=wⁿ+w^{gp} is the mass fraction of reacted water (non-evaporable water plus gel pore water) per mass of hydrated cement, v^{cl} , v^{w}, and V^{r} are the specific volumes of each phase.

The constants of Equations 19-22 were determined from experimental results and used to develop the following expression for the non-evaporable water content as a function of the mass fractions, pᵢ, for the major compounds of Portland cement as shown below in Equation 23:

wⁿ=0.257p_{C}_{₃}_{S}+0.217p_{C}_{₂}_{S}+0.56p_{C}_{₃}_{A}+0.202p_{C}_{₄}_{AF} (23)

where the major compound abbreviation C₃S is tricalcium silicate, C₂S is dicalcium silicate, C₃A is tricalcium aluminate, and C₄AF is tetracalcium aluminoferrite.

Using a least squares fit to a subset of published data the reacted water content may be calculated to give Equation 24, where p_{CS̅} is the mass fraction of calcium sulfate.

(w^{r})^{P-B}=0.334p_{C}_{₃}_{S}+0.374p_{C}_{₂}_{S}+1.410p_{C}_{₃}_{A}+0.471p_{C}_{₄}_{AF}+0.261p_{CS̅} (24)

Equation 24 and the fit of wⁿ to published data can then be used to calculate the gel pore ratio, and thus the gel pore water content in Equation 25:

$${w}^{gp} = \frac{{( {w}^{r} )}^{P - B} - {( {w}^{n} )}^{P - B}}{{( {w}^{n} )}^{P - B}} \times {w}^{n} \qquad ( 25 )$$

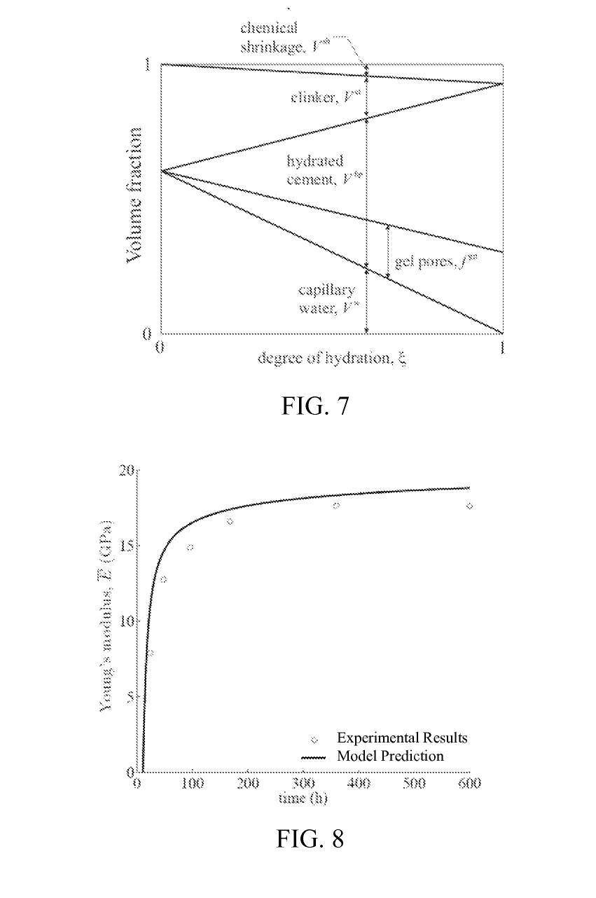

and the reacted water content, w^{r}=wⁿ+w^{gp}. Published results for the specific volume of each category of water can be used to calculate the specific volume of the reacted water, v^{r}+(wⁿvⁿ+w^{gp}v^{gp})/w^{r}, and the gel porosity of the hydration product, ƒ^{gp}=w^{gp}v^{gp}/(v^{cl}+w^{r}v^{r}). The hydration functions can then be computed as shown in Equations 19-22. The hydration functions for a typical Portland cement are shown in FIG. 7.

The hydration functions, together with the elastic moduli of the C-S-H particles and the clinker particles, permit the macroscopic elastic moduli of the cement paste to be calculated from the water to cement ratio and the mass fractions of the compounds of the clinker. FIGS. 8, 9, and 10 show that this model can predict elastic moduli measured experimentally.

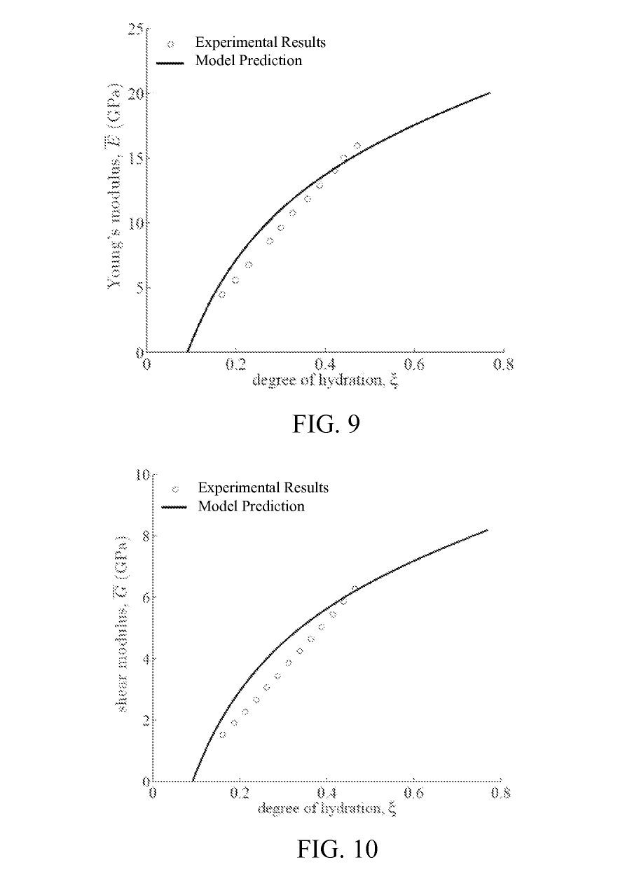

With particular respect to FIG. 8, predictions of Young's modulus Ē(ξ), for a type G Portland cement at a water to cement ratio (w/c) of 0.4 are shown as a function of time in hours. The graph shows that the model is in good agreement with the experimental results as the cement hydrates quickly within the first few hours as the hydration reaction progresses and continues to increase in rigidity over the studied interval. Similarly, with particular respect to FIG. 9, predictions of Young's modulus Ē(ξ) for a type G Portland cement at a w/c of 0.4 as a function of the degree of hydration also appear to be in agreement with the model over the studied interval. With particular respect to FIG. 10, the model predictions of the exponential decrease in permeability as a function of degree of hydration also matched that observed in experiments. With particular respect to FIG. 10, predictions of shear modulus G̅(ξ) for a type G Portland cement at a w/c of 0.4 as a function of the degree of hydration also appear to be in agreement with the model over the studied interval.

Modeling the Hydration Reaction

The terms in Equations 5 and 6 describing the chemical reaction can also be determined from the hydration functions defined in the preceding section. The derivative of the macroscopic porosity (Equation 5) with respect to the degree of hydration is shown below in Equation 26.

$$\frac{\partial \overline{φ}}{\partial ξ} ≡ {( \frac{\partial \overline{φ}}{\partial ξ} )}_{{E}_{v} , p} = \frac{d {\overline{φ}}_{ch}}{d ξ} \qquad ( 26 )$$

By conducting experiments with boundary conditions of approximately constant strain (dEᵥ=0) and constant pressure (dp=0), the change in macroscopic porosity is assumed to be due entirely to the chemical reaction, and Equation 26 can be equated to the total rate of change of porosity predicted by the hydration functions as shown in Equation 27.

$$\frac{d {\overline{φ}}_{ch}}{d ξ} = \frac{d {V}^{w}}{d ξ} + \frac{d {V}^{sh}}{d ξ} + {f}^{gp} \frac{d {V}^{h p}}{d ξ} \qquad ( 27 )$$

Similarly, the rate of consumption of water, defined as the rate at which water becomes chemically bound within the C-S-H particles, can be expressed in terms of the hydration functions as shown in Equation 28.

$${\dot{m}}_{f \to s} = {m}_{f \to s}^{∞} \frac{d ξ}{d t} = - ( \frac{1}{{v}^{w}} \frac{d {V}^{w}}{d ξ} + \frac{1}{{v}^{gp}} {f}^{gp} \frac{d {V}^{h p}}{d ξ} ) \frac{d ξ}{d t} \qquad ( 28 )$$

Inserting the preceding two equations into the expression for the increment in fluid content (Equation 6), produces the following relationship defined in Equation 29:

$$d ζ = \overline{α} ( ξ ) {dE}_{v} + \frac{dp}{\overline{M} ( ξ )} + {f}^{gp} {dV}^{h p} ( 1 - \frac{{v}^{w}}{{v}^{gp}} ) + {dV}^{sh} \qquad ( 29 )$$

where the constrained specific storage coefficient is introduced in Equation 30.

$$\frac{1}{\overline{M} ( ξ )} ≡ ( \frac{1}{\overline{N} ( ξ )} + \frac{\overline{φ} ( ξ )}{{k}_{w}} ) \\ \frac{d {\overline{φ}}_{ch}}{d ξ} and {\dot{m}}_{f \to s} \qquad ( 30$$

may also be estimated from the stoichiometry of the chemical reaction.

Simulating Deformation and Stress in a Wellbore Cement Sheath

Methods in accordance with the present disclosure may also include the step of simulating mechanical loading on a formed cement sheath. First, at a specified depth, the hydrostatic stress in the cement at the time of placement is calculated. This hydrostatic stress is caused by the self-weight of the cement at that depth and the weight of any fluid column above the cemented section of the annulus. The increment of stress caused by hydration of the cement is then added to this hydrostatic stress to calculate the initial stress in the cement sheath (the stress in the cement before any mechanical loading is imposed on the cement sheath). Mechanical loading may include expansion or contraction of the casing due to changes in well pressure (pressure test, fluid swap, stimulation, production) and changes in formation stress caused by creep or subsidence. These mechanical loads place an additional increment of stress upon the cement sheath. At a specified depth, the increment of stress caused by mechanical loading is added to the initial stress in order to determine the total stress in the cement sheath. The total stress may then be compared with failure criteria for the cement to determine if the mechanical loading will cause the cement sheath to fail.

For example, methods of determining one or more stresses of an annular cement sheath of a wellbore may include determining volume fractions for a number of phases within the cement sheath as a function of degree of hydration; determining one or more poroelastic properties for the cement sheath as a function of degree of hydration; and determining the pore pressure of the cement body as a function of degree of hydration. In some embodiments, one or more stresses within the cement sheath may then be calculated using (i) the poroelastic properties for the cement sheath, (ii) pore pressure of the cement sheath, (iii) a mechanical property of the casing, (iv) geometry of the casing, (v) geometry of the wellbore, and (vi) wellbore conditions (e.g., depth, temperature, formation pore pressure, elastic properties of the formation, and fluid column weight).

In the preceding sections, the constitutive relation (Equation 4) and the increment in fluid content (Equation 29) of the cement paste has been derived. These equations, together with the balance laws and the expression for the fluid seepage velocity, determine the partial differential equations (PDEs) governing the deformation and pore pressure of the solid. In this section, a finite element technique for solving these coupled PDEs for the geometry and boundary conditions of a cement body is described, such as a well-cement sheath.

For the isothermal case and assuming small and quasi-static deformations, the appropriate balance laws are the Cauchy equilibrium equation and the fluid continuity equation. The equilibrium equation is shown below in Equation 31:

T_{ij,}_{ⱼ}+Fᵢ=0 (31)

where the macroscopic stress in the cement Tᵢⱼ is calculated by adding the increment of stress in equation 4 to the hydrostatic stress in the cement at the time of placement and Fᵢ is the body force, if present (e.g., gravity).

The fluid continuity equation for small spatial variations in both porosity and density and without any source densities is written as shown in Equation 32:

$$\frac{\partial ζ}{\partial t} + {q}_{i , i} = 0 \qquad ( 32 )$$

where q_{i,i} are the components of the fluid flux vector, q.

For sufficiently slow flow rates and small spatial variations of permeability, substitution of Darcy's law and using equation 29 with v^{w}=v^{gp} provides the diffusion equation for the pore pressure shown in Equation 33:

$$\frac{1}{\overline{M} ( ξ )} \frac{\partial p}{\partial t} = \frac{\overline{κ} ( ξ )}{μ} {∇}^{2} p - \overline{α} ( ξ ) \frac{\partial {E}_{v}}{\partial t} - \frac{\partial {V}^{sh}}{\partial t} \qquad ( 33 )$$

where κ̅(ξ) is the evolving permeability of the cement and μ is the viscosity of water. On the right-hand side of equation 33, the rates of volumetric strain and chemical shrinkage act mathematically as source terms. Equation 33 shows that simulating hydration of the cement includes calculating pore pressure for the cement body and accounting for changes in pore pressure associated with chemical shrinkage of the cement. Using a Galerkin weighted residual approach, equations 31 and 33 are then multiplied, respectively, by trial displacement functions, δᵤ_{ᵢ}, and by trial pore pressure functions, δp, and integrated over a reference volume. The reference volume is discretized into finite elements, and the displacement and pore pressure within each element are interpolated from the values at the nodes of the element. The global system of equations is solved implicitly for the unknown degrees of freedom. A non-symmetric solution technique can be used for the solution to converge efficiently because the governing equations are coupled.

At the boundaries of the finite element mesh of the cement sheath, the displacement or the traction is prescribed for each displacement degree of freedom, and the pore pressure or the fluid flux is prescribed for each pore pressure degree of freedom. At the inner radius of the sheath, the casing is explicitly modeled with linear elastic finite elements, and the fluid flux is zero in the absence of debonding. At the outer radius, for an axisymmetric annulus and a linear elastic formation, the traction vector is a function of the shear modulus of the formation, G^{form}, and the radius of the hole as shown in Equation 34:

$$T ( {r}_{o} {e}_{r} , t ) {e}_{r} = - \frac{2 {G}^{form}}{{r}_{o}} {u}_{r} ( {r}_{0} {e}_{r} , t ) {e}_{r} \qquad ( 34 )$$

which is the analytic solution for an internally pressurized cylindrical hole in a semi-infinite elastic body.

The fluid flux at the outer radius of an actual cement sheath is a complex function of the cement pore pressure, the formation pore pressure, the formation permeability, and the properties of the cake skin of cement and mud that forms during placement of the cement. Here, the effects of these variables can be lumped into two skin parameters, κ^{skin} and t^{skin}, calculating the flux as shown in Equation 35:

$$q ( {r}_{o} {e}_{r} , t ) = - \frac{{κ}^{skin}}{{t}^{skin}} ( {p}^{cem} ( {r}_{o} {e}_{r} , t ) - {p}^{form} ) \qquad ( 35 )$$

where the formation pressure is approximated to remain constant at the time scale of several days. The finite element method may also be used to model the fluid flow in the cake skin and the formation when given accurate measurements of the permeability of each material.

In order to integrate the governing equations, the current degree of hydration may be determined for each time increment in some embodiments. The rate of hydration can be measured, for example, by isothermal calorimetry tests conducted at different temperatures. A fit of the normalized chemical affinity A(ξ) and the activation energy Eₐ to the calorimetry data determines the Arrhenius equation describing the hydration reaction shown below in Equation 36,

$$\frac{d ξ}{d t} = A ( ξ ) exp ( - \frac{{E}_{a}}{RT} ) \qquad ( 36 )$$

where the chemical affinity is given by an expression of the form shown in Equation 37.

A(ξ)=aξ^{b}(1−ξ)^{c} (37)

Equation 36 is then integrated over each time increment in order to determine the current degree of hydration of a cement sheath.

Predicting Total Stress on a Formed Cement Sheath

In one or more embodiments, methods in accordance with the present disclosure may include a step of predicting total stress in a formed cement sheath, including the stress contributions from hydration, which determine the initial state of stress, and the stress contributions to mechanical loading, and determining whether such stresses are sufficient to cause the cement sheath to fail. For example, compressive stresses within a cement sheath can be caused by an increase of wellbore pressure or formation stress, placing the cement at risk of shear failure. Further, tensile stresses in the tangential (or hoop) direction, caused by an increase in cement pore pressure or wellbore pressure, for example, can cause the cement to fracture in the radial or axial direction.

Other sources of stress include tensile stress in the radial direction produced, for example, from a decrease in fluid pressure within the wellbore or decreases in temperature of fluid within the wellbore or cement, may cause the cement sheath to debond from the formation and/or the casing, forming a microannulus.

In one or more embodiments, predictions of the total stress on a formed cement sheath may include a determination of one or more of the maximum tensile effective stress, the maximum compressive stress, and the radial stress at the inner radius and outer radius of the cement sheath. Further, the maximum values for the stress modes may be calculated based on the wellbore conditions and results of simulating the hydration of the cement composition.

The total stress for the cement sheath can be determined using various different methodologies. For example, a finite element technique, as shown in the Examples section below can be used to determine total stress for the cement sheath. The inputs to the finite element technique can be the cement material properties, geometry of the wellbore, wellbore conditions, formation conditions, the equilibrium equation defined in Equation 31, and the diffusion equation for the pore pressure of the cement defined in Equation 33. Other methodologies for determining total stress include finite difference techniques and/or analytic methods.

Selection of a Cement Composition

In one or more embodiments, methods in accordance with the present disclosure may include a step of designing or redesigning a cementing operation to modify a cement composition such that the structural properties of the final cement sheath approach, meet, or fall below a predetermined failure criteria. For example, methods may include inputting cement operation parameters based on a selected cement composition, using modeling techniques to determine cement sheath failure based on the given wellbore conditions, and designing the cementing operation in order to prevent the predicted failure mode.

In some embodiments, when a cement sheath is predicted to fail a cement operation may be engineered to include a cement with a lower elastic modulus or higher compressive strength. For example, if the cement sheath is predicted to fail by fracture, a cement composition with a lower elastic modulus or higher tensile strength may be used, or formation supports may be added as reinforcement. In another example, if the cement sheath is predicted to fail by debonding from the casing or formation, cement compositions modified to reduce chemical shrinkage may be used, such as a cement that incorporates an expanding agent or inert components that compensate for the shrinkage of the cement component.

Other approaches to strengthen a cement job may include reducing the load placed on the cement sheath by changes of well pressure by increasing the weight (thickness) of the casing, or reducing the range of allowable pressures within the wellbore. In some embodiments, wellbore costs may be a consideration and cement compositions may be selected such that the cement sheath properties are near the failure criteria, or below the criteria for a predetermined period of time in which operations may be completed before anticipated failure, in order to reduce expenses associated with specialty cements or cement additives.

Cement compositions in accordance with the present disclosure may include hydraulic cement compositions that react with an aqueous fluid or other water source and harden to form a barrier that prevents the flow of gases or liquids within a wellbore traversing an oil or gas reservoir. In one or more embodiments, the cement composition may be selected from hydraulic cements known in the art, such as those containing compounds of calcium, aluminum, silicon, oxygen and/or sulfur, which set and harden by reaction with water. These include “Portland cements,” such as normal Portland or rapid-hardening Portland cement, American Petroleum Institute (API) Class A, C, G, or H Portland cements, sulfate-resisting cement, and other modified Portland cements, high-alumina cements, and high-alumina calcium-aluminate cements.

Other cements may include phosphate cements and Portland cements containing secondary constituents such as fly ash, pozzolan, and the like. Other water-sensitive cements may contain aluminosilicates and silicates that include ASTM Class C fly ash, ASTM Class F fly ash, ground blast furnace slag, calcined clays, partially calcined clays (e.g., metakaolin), silica fume containing aluminum, natural aluminosilicate, feldspars, dehydrated feldspars, alumina and silica sols, synthetic aluminosilicate glass powder, zeolite, scoria, allophone, bentonite, and pumice.

In some embodiments, cements may include Sorel cements such as magnesium oxychloride (MOC) cement, magnesium oxysulfate (MOS), magnesium phosphate (MOP), and other magnesium-based cements formed from the reaction of magnesium cations and a number of counter anions including, for example, halides, phosphates, sulfates, silicates, aluminosilicates, borates, and carbonates.

In one or more embodiments, the set time of the cement composition may be controlled by, for example, modifying the amount of water in the cement composition, varying the particle size of the cement components, or varying the temperature of the composition. The ratio of water to cement (w/c) ratio may be used in some embodiments to control the setting time and the final hardness of a cement composition. For example, increasing the water concentration may reduce cement strength and increase set times, while decreasing water concentration may increase strength, but may reduce the workability of the cement.

Cement Additives

In some embodiments, the rigidity of the final cement may be modified by including various additives such as polymers that increase the stability of the cement suspension during delivery, and may modify physical properties such as compressive strength. Cement compositions may also contain setting accelerators, retarders, or air-entraining agents that modify the density of the final cement.

In one or more embodiments, cement compositions may contain one or more hydration retarders known in the art to increase the workable set time of the resulting cement. Hydration retarders in accordance with the present disclosure may delay setting time and take into account increased temperatures encountered in many subterranean formations, allowing greater control of cement placement in a number of varied formations and conditions. Hydration retarders may also increase the durability of a cement composition in some embodiments by reducing reaction kinetics and encouraging thermodynamic crystallization of cement components, minimizing crystal defects in the final cement product.

Hydration retarders in accordance with the present disclosure may serve several purposes such as adjusting the set profile of a cement composition and/or improve strength and hardness of the cement. Without being limited by a particular theory, retarders may operate by interacting with cement components through ionic interactions that prevent the cement components from agglomerating and incorporating into the matrix of the setting cement. Other possible chemical mechanisms may include reducing the rate of hydration by physically coating the unhydrated cement particles with hydration retarders and preventing water access.

In one or more embodiments, hydration retarders may include polymeric crystal growth modifiers having functional groups that stabilize cement components in solution and slow the formation of the cement matrix. For example, hydration inhibitors may include natural and synthetic polymers containing carboxylate or sulfonate functional groups, polycarboxylate polymers such as polyaspartate and polyglutamate, lignosulfonates, and polycarboxylic compounds such as citric acid, polyglycolic acid. Other suitable polymers may include sodium polyacrylates, polyacrylic acid, acrylic acid-AMPS-methylpropane sulfonic acid copolymers, polymaleic acid, polysuccinic acid, polysuccinimide, and copolymers thereof.

Hydration retarders may also include compounds that interrupt cement hydration by chelating polyvalent metal ions and forming hydrophilic or hydrophobic complexes with cement components. In one or more embodiments, hydration retarders may include one or more polydentate chelators that may include, for example, ethylenediaminetetraacetic acid (EDTA), diethylenetriaminepentaacetic acid (DTPA), citric acid, nitrilotriacetic acid (NTA), ethylene glycol-bis(2-aminoethyl)-N,N,N′,N′-tetraacetic acid (EGTA) , 1,2-bis(o-aminophenoxy)ethane-N,N,N′,N′-tetraaceticacid (BAPTA), cyclohexanediaminetetraacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), iminodisuccinic acid, ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), salts thereof, and mixtures thereof.

In other embodiments, hydration retarders may include sulfonated phenolic and polyphenolic compounds such as lignosulfonates and sulfonated tannins, organophosphates, amine phosphonic acids, hydroxycarboxylic acids, and sulfonated and/or carboxylated derivatives of carbohydrates and sugars. Other hydration retarders may include boric acid, borax, sodium pentaborate, sodium tetraborate, and proteins such as whey protein.

In some embodiments, cement compositions may include hydration accelerators that increase the temperature of the hydrating cement through exothermic reactions (e.g., magnesium oxide, calcium oxide), and thereby increase the rate of setting or hardening of the composition.

Cement compositions in accordance with the present disclosure may also include an inert agent selected from a variety of inorganic and organic fillers that may become entrained as the cement composition sets. Inert agents may modify the density, plasticity, and hardness of the final cement and may include, for example, saw dust, wood flour, cork, stones, marble flour, sand, glass fibers, mineral fibers, carbon fibers, and gravel.

In one or more embodiments, cement compositions in accordance with methods described herein may include one or more expanding agents such as magnesium oxide, calcium oxide, calcium trisulfoaluminate hydrate, and other compounds that react with water to form hydrates with greater volume that the starting solid reactant. Other expanding agents may include low-density porous additives, and expandable polymeric materials that swell in response to contact with aqueous or non-aqueous fluids (depending on the chemistry of the selected polymeric material).

Other additives may include those that modify the mechanical properties of a formed cement sheath such as the elasticity and ductility of the cement. In one or more embodiments, mechanical modification of the cement sheath may include adding one or more rubber components such as natural rubber, acrylate butadiene rubber, polyacrylate rubber, isoprene rubber, choloroprene rubber, butyl rubber (IIR), brominated butyl rubber (BIIR), chlorinated butyl rubber (CIIR), chlorinated polyethylene (CM/CPE), neoprene rubber (CR), styrene butadiene copolymerrubber (SBR), styrene butadiene block copolymer rubber, sulphonated polyethylene (CSM), ethylene acrylate rubber (EAM/AEM), epichlorohydrin ethylene oxide copolymer (CO, ECO), ethylene-propylene rubber (EPM and EDPM), ethylene-propylene-diene terpolymer rubber (EPT), ethylene vinyl acetate copolymer, fluorosilicone rubbers (FVMQ), silicone rubbers (VMQ), poly 2,2,1-bicyclo heptene (polynorbrneane), alkylstyrene, and crosslinked substituted vinyl acrylate copolymers.

### EXAMPLES

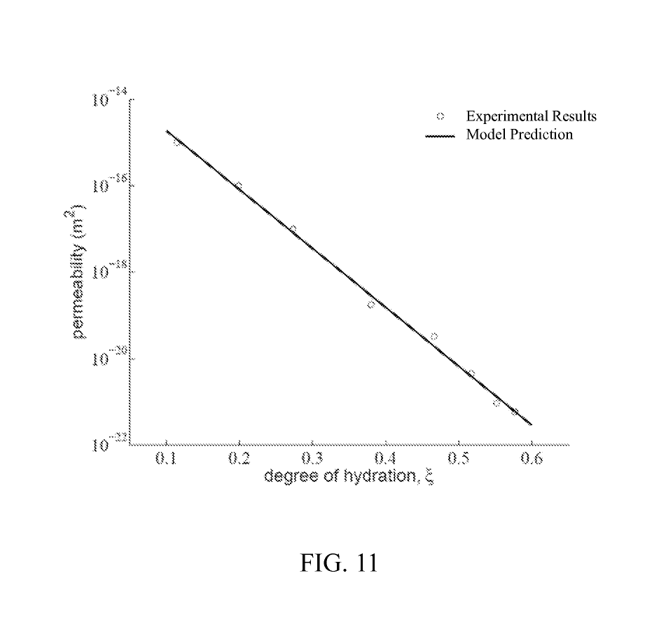

This section demonstrates an embodiment in accordance with the present disclosure in which a model was used to predict the results of homogeneous experiments on a class G Portland cement. Further, the model may be used to simulate the hydration and subsequent loading of a cement sheath downhole. The model uses a cement permeability that decreases exponentially with increasing degree of hydration, as shown in FIG. 11. The other inputs to the model are summarized in Table 1 below.

TABLE 1
Summary of input properties used to model class G Portland cement.

| | | | | | | |
|---|---|---|---|---|---|---|
| Mass | p_{C}₃S | 0.626 | Elastic Moduli | kₛ | 40.5 | GPa |
| fractions | | | of C-S-H Particles | | | |
| of clinker | | | | | | |
| | p_{C}₂S | 0.159 | | gₛ | 24.3 | GPa |
| | p_{C}₃A | 0.048 | Specific Volumes | v^{cl} | 0.317 | cm³/g |
| | p_{C}₄AF | 0.109 | | v^{w} | 0.988 | cm³/g |
| | p_{CS̅} | 0.03 | | v^{gp} | 0.988 | cm³/g |
| Elastic | K^{clink} | 105.2 GPa | | vⁿ | 0.752 | cm³/g |
| Moduli | | | | | | |
| of Clinker | | | | | | |

| | | | | |
|---|---|---|---|---|
| G^{clink} | 44.8 GPa | Gel Pore Volume | f^{gP} | 0.326 |

| | | | |
|---|---|---|---|
| Fraction | | | |
| (calculated) | | | |
| Bulk Modulus | k_{w} | 2 | GPa |
| of Water | | | |

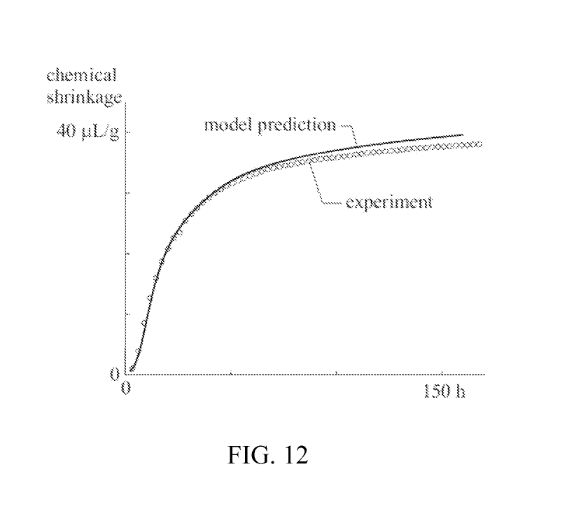

With particular respect to FIG. 12, the model predicts the experimentally measured chemical shrinkage of the cement paste. In this experiment, the cement hydrated under open and drained conditions and a volumetric pump measured the amount of water that entered the sample, which provided a measure of the chemical shrinkage.

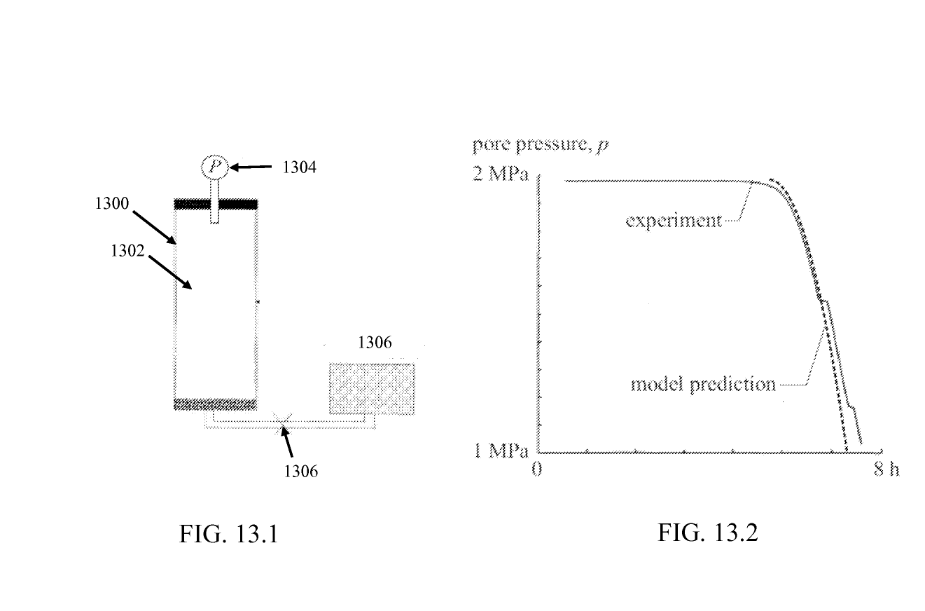

The model was also used to predict the change in the pore pressure of the cement caused by the hydration reaction. For example, in FIGS. 13.1 and 13.2, the predictions of the model were compared to the results of a hydration experiment conducted under sealed conditions and at constant external stress using the apparatus shown in FIG. 13.1.

The apparatus includes a chamber 1300 submerged in an oil bath in which the cement composition 1302 hydrates. As the cement hydrates, the radial component of the stress Tᵣᵣ remains constant and pore pressure with the cement composition is measured using a pore pressure sensor 1304. In FIG. 13.1 the valve 1306 to water supply is closed so that the cement composition has no access to water. The model predicts the sharp drop in pore pressure that occurs soon after the cement percolates (solidifies) as shown in FIG. 13.2.

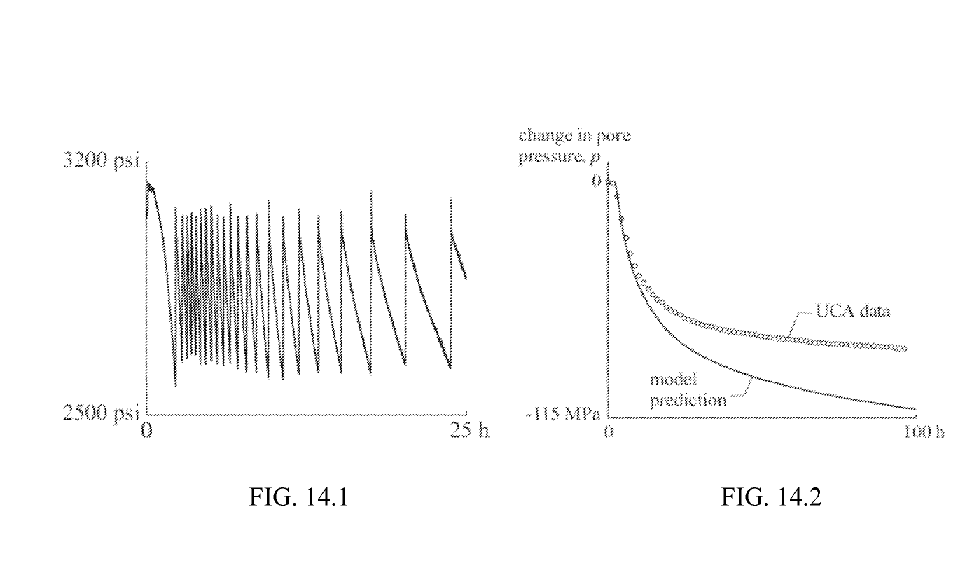

With particular respect to FIGS. 14.1 and 14.2, the model predicts a decrease in pore pressure similar to the decrease calculated from experiments conducted under temporarily sealed conditions. In these experiments, a pump supplying water to the system continually cycled on after chemical shrinkage of the cement causes the pressure in the system to drop by about 3.5 MPa (500 psi), returning the system to its original setpoint pressure.

The total drop in pressure was estimated by summing the pressure oscillations as shown in FIG. 14.1. The total pressure was defined as the pressure a specimen sealed under these conditions would experience if the initial pressure were high enough to prevent desaturation of the pores. The model overpredicted the pressure drop somewhat, which is attributed to a pressure gradient developed within the relatively large cement sample when the permeability of the cement decreased as shown in FIG. 14.2.

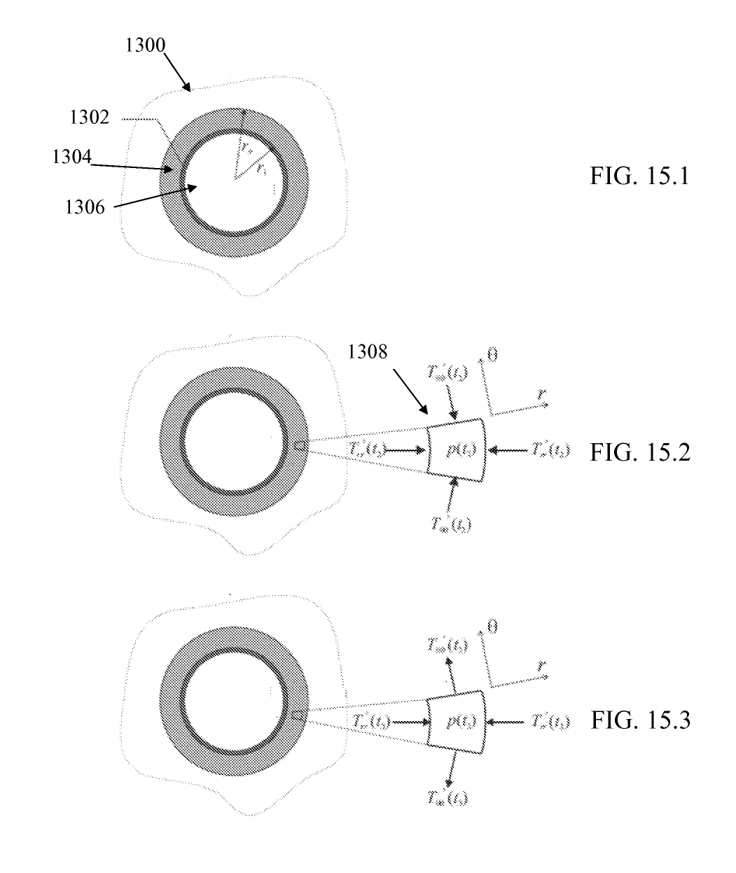

Next, with particular respect to FIGS. 15.1-15.3, a finite element approach was used to model the stress downhole in a cement annulus during the first 48 hours of hydration and a subsequent increase of internal casing pressure to 40 MPa for both a soft formation (2 GPa, characteristic of a soft sandstone) and a stiff formation (20 GPa, characteristic of a hard shale). The elasticity of a formation, softness or stiffness, may be quantified by techniques known in the art such as acoustic logging and/or core sampling.

FIG. 15.1 shows the injected cement slurry at t=0, FIG. 15.2 shows the consolidating cement at t=48 h, and FIG. 15.3 shows the application of stress on the inner casing at after 48 hours. Square and biquadratic axisymmetric finite elements of characteristic length h=1 mm were used.

With particular respect to FIG. 15.1, a cross-section of a wellbore traversing a formation 1300 is shown. A casing 1302, having an inner radius rᵢ and outer radius rₒ, contains a wellbore fluid 1306 in its interior and is held in place by a cement sheath 1304 having a starting hydrostatic stress at the time of placement (Tᵢⱼδᵢⱼ) of 40 MPa. With particular respect to 15.2, a unit of the hydrating cement 1308 is shown in an inset diagram and axis that illustrates the various stress components acting on the unit as the cement consolidates. These stresses determine the initial stress in the cement sheath, which is the state of stress present before the loads are imposed by changes in wellbore conditions. When the casing pressure is increased by 40 MPa, the stresses acting on the hydrated cement unit change accordingly and the cement stretches in the direction of the θ axis as shown in the inset diagram of FIG. 15.3. The additional parameters used in these simulations are summarized in Table 2 below.

TABLE 2
Summary of input properties used to simulate the cement sheath.

| Water to cement ratio | w/c | 0.42 | |
|---|---|---|---|
| Percolation threshold (calculated) | ξ₀ | 0.1144 | |
| Temperature of cement | θ | 40° | C. |
| Total stress in cement at time of placement | Tᵢⱼδᵢⱼ | 40 | MPa |
| Pore pressure in cement at time of placement | p₀ | 40 | MPa |
| Sheath inner radius | rᵢ | 9.7 | cm |
| Sheath outer radius | rₒ | 13.3 | cm |
| Casing thickness | t^{casing} | 8 | mm |
| Formation shear modulus | G^{form} | 2 GPa or 20 GPa | |
| Formation pore pressure | p^{form} | 20 | MPa |
| Skin permeability | κ^{skin} | 10⁻¹⁸ | m² |
| Skin thickness | t^{skin} | 1 | mm |

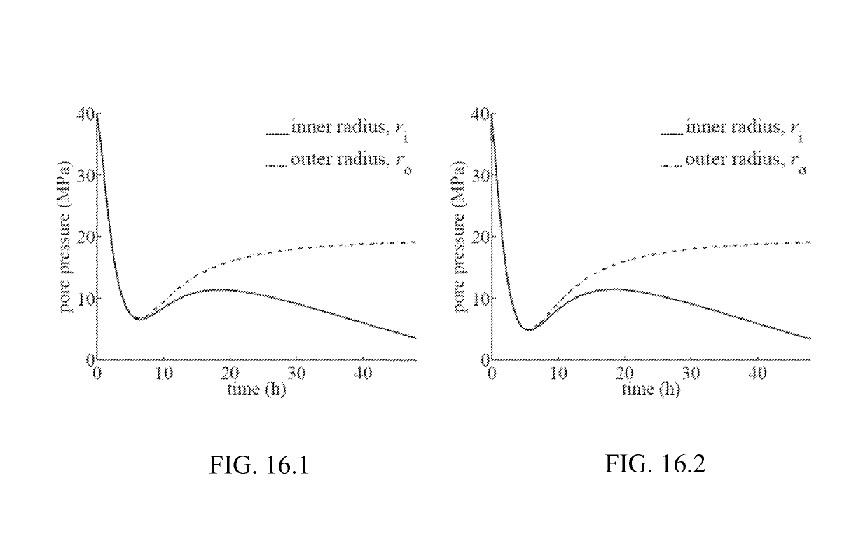

With particular respect to FIGS. 16.1 and 16.2, graphical for the finite element analysis is presented in which the pore pressure in the cement initially declines quickly due to the flow of water into the formation and the effect of chemical shrinkage. At both the inner radius and the outer radius, the pore pressure actually drops below the pore pressure in the formation. Then, at the outer radius, the pore pressure gradually approaches the formation pressure. At the inner radius, however, after a brief increase, the pore pressure continues to decline because the permeability of the cement is decreasing exponentially as the degree of hydration increases. The pore pressures are slightly lower in the case of the stiff formation (FIG. 16.2) because the stiff formation unloads more quickly than the soft formation shown in FIG. 16.1.

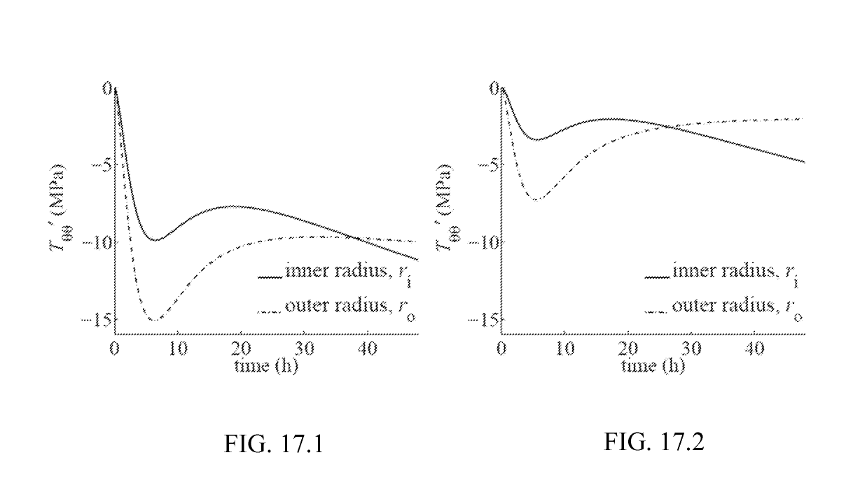

With particular respect to FIGS. 17.1 and 17.2, the effective hoop stress, defined as the total hoop stress plus the contribution of the pore pressure from the cement, T′_{θθ}≡T_{θθ}+p, demonstrates that the stiff formation (FIG. 17.1) unloads more quickly than the soft formation (FIG. 17.2) during the hydration process. The maximum hoop stress is about −10 MPa (compressive) for the soft formation in FIG. 17.1, but it is about −2 MPa for the stiff formation in FIG. 17.2. Radial fracture caused by tensile hoop stresses is a primary mode of failure of the cement sheath. Exhibiting a considerable compressive initial stress, the cement placed against a soft formation therefore appears to have a significant factor of safety against radial or axial cracking due to tensile stress increments caused by changes of wellbore conditions.

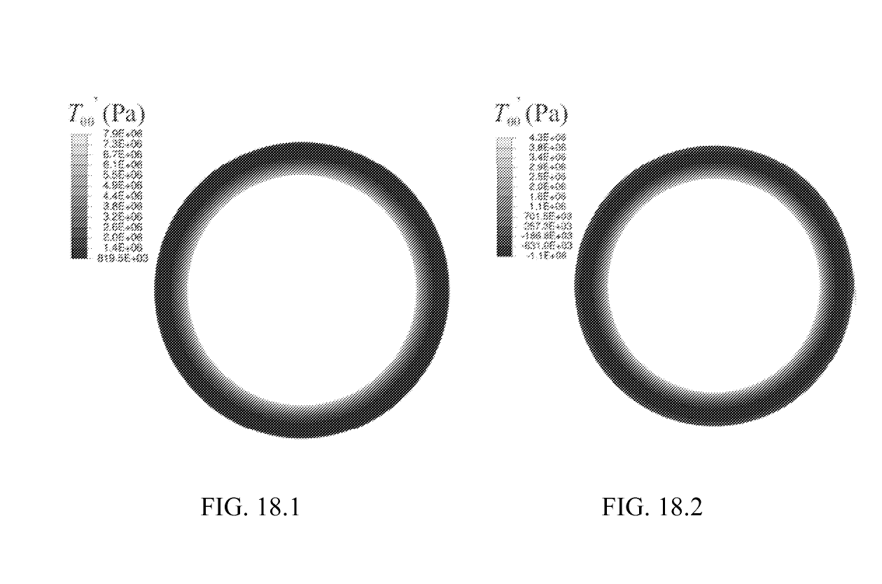

With particular respect to FIGS. 18.1 and 18.2, a second loading step simulates increasing the internal casing pressure by 40 MPa in a time period of 5 min. The maximum hoop stress is tensile at the inner radius for both types of formations. Despite having a compressive “initial” state of stress of about 10 MPa, the cement placed against the soft formation in FIG. 18.1 carries a greater risk of radial cracking (T′_{θθ}|ₘₐₓ=7.9 MPa) than the cement placed against the stiff formation (T′_{θθ}|ₘₐₓ=4.3 MPa) in FIG. 18.2. The increase in risk occurs because the soft formation provides a much lower confinement force to the cement than the stiff formation does. This example illustrates how the degree and rate of hydration, the permeability of the cement, the exchange of fluid between the cement and the formation, and the response of the formation impact the current stress in the cement. The effects of these parameters can be extensively explored with the methods and processes described herein.

In one or more embodiments, methods in accordance with the present disclosure may also be extended to (i) simulation of temperature changes and gradients caused by heat of hydration and conduction through the casing and formation, (ii) cases of debonding of the cement sheath from the casing and formation, (iii) cases of non-symmetric annular geometries, and (iv) cases of non-linear formation response.

Any of the equations, algorithms, and processes described herein, such as (i) determining a stress for a cement body, (ii) determining volume fractions for phases within the cement body as a function of degree of hydration, (iii) determining poroelastic properties for the cement body as a function of degree of hydration, (iv) determining pore pressure of the cement body as a function of degree of hydration, (v) determining a stress of an annular cement sheath of a wellbore, and (vi) determining elastic moduli of cement, may be performed by a processing system.

The term “processing system” should not be construed to limit the embodiments disclosed herein to any particular device type or system. The processing system may be a computer, such as a laptop computer, a desktop computer, or a mainframe computer. The processing system may include a graphical user interface (GUI) so that a user can interact with the processing system. The processing system may also include a processor (e.g., a microprocessor, microcontroller, digital signal processor, or general purpose computer) for executing any of the methods and processes described above (e.g. processes (i)-(vi)).

The processing system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. This memory may be used to store, for example, the model described herein, inputs for the model, and outputs for the model.

Any of the methods and processes described above, including processes (i)-(vi), as listed above, can be implemented as computer program logic for use with the processing system. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the processing system. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

In some embodiments, the processing system may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

The processes and methods described herein are not limited to designing cementing operations for cement bodies within wellbores. For example, the processes and methods described herein can be used to design cementing operations for surface applications, such as cementing operations for large cement or concrete structures, such as dams, bridges, walls, and foundations.

Although only a few examples have been described in detail above, those skilled in the art will readily appreciate that many modifications are possible in the examples without materially departing from this subject disclosure. Accordingly, all such modifications are intended to be included within the scope of this disclosure.

What is claimed:

1. A method of designing a cementing operation for a cement body within a wellbore, the method comprising:
determining a stress for the cement body within the wellbore by simulating hydration of the cement body using a plurality of cementing operation parameters and a plurality of wellbore conditions, wherein simulating hydration of the cement body comprises calculating pore pressure for the cement body and accounting for changes in pore pressure associated with chemical shrinkage of the cement body; and
designing a cementing operation using the stress for the cement body and the plurality of cementing operation parameters.

2. The method of claim 1, wherein designing the cementing operation comprises:
comparing the stress for the cement body to failure criteria associated with the cement body.

3. The method of claim 2, wherein, if the stress is below the failure criteria, performing the cementing operation according to the plurality of cementing operation parameters used in the simulation.

4. The method of claim 2, wherein, if the stress is above the failure criteria, modifying at least one of the plurality of cementing operation parameters used in the simulation.

5. The method of claim 4, wherein modifying at least one of the plurality of cementing operation parameters comprises modifying cement composition of the cement body.

6. The method of claim 5, wherein modifying the cement composition of the cement body comprises at least one of:
(i) changing mass fractions of cement components,
(ii) changing particle size for cement components,
(iii) adding a hydration retarder,
(iv) adding an accelerant,
(v) altering the water to cement ratio,
(vi) adding a rubber component,
(vii) adding an expanding agent, and
(viii) adding an inert agent.

7. The method of claim 4, further comprising
determining a stress for the cement body using the modified cementing operation parameters; and
verifying that the modified cementing operation parameters produce a stress that is below the failure criteria.

8. The method of claim 1, wherein determining the stress for the cement body within the wellbore comprises simulating changes in wellbore conditions acting upon the cement body.

9. The method of claim 8, wherein determining the stress for the cement body within the wellbore comprises: (i) determining an initial state of stress for the cement body by simulating hydration of the cement body, (ii) determining changes in stress caused by changing wellbore conditions by simulating changes in wellbore conditions acting upon the cement body, and (iii) determining the stress for the cement body using the initial state of stress and the changes in stress caused by changing wellbore conditions.

10. The method of claim 1, wherein the cement body is a cement sheath emplaced between casing and a formation.

11. The method of claim 10, wherein the plurality of cementing operation parameters comprises at least two of:
(i) cement composition,
(ii) mechanical properties of cement components;
(iii) casing dimensions;
(iv) mechanical properties of the casing; and
(v) number of stages in the cementing operation.

12. The method of claim 10, wherein the plurality of wellbore conditions comprises at least two of:
(i) mechanical properties of the formation,
(ii) temperature of the formation,
(iii) pore pressure of the formation,
(iv) depth within the wellbore;
(v) wellbore geometry;
(vi) wellbore dimensions;
(vii) weight of a fluid column above the cement sheath; and
(vii) fluid pressure in the casing.

13. The method of claim 10, wherein simulating the hydration of the cement sheath comprises using poroelastic properties for the cement sheath, pore pressure of the formation, and initial stress for the cement sheath at the time of placement.

14. The method of claim 1, wherein simulating the hydration of the cement body comprises calculating elastic moduli for a hydration product of the cement body using:
(i) elastic moduli for calcium-silicate-hydrate solid particles of the cement body,
(ii) elastic moduli for clinker components of the cement body,
(iii) a volume fraction for clinker components of the cement body,
(iv) a volume fraction for gel pores of the cement body,
(v) a volume fraction for capillary water, and
(vi) a volume fraction for chemical shrinkage.

15. The method of claim 14, wherein simulating the hydration of the cement body comprises:
determining a volume fraction for one or more phases within the cement body using at least one hydration function for the one or more phases.

16. The method of claim 15, wherein the at least one hydration function comprises at least one of:
(i) a hydration function for volume fraction of unreacted water;
(ii) a hydration function for volume fraction of clinker components;
(iii) a hydration function for volume fraction of hydration product; and
(iv) a hydration function for volume fraction of chemical shrinkage.

17. The method of claim 1, wherein simulating the hydration of the cement body comprises determining a volume fraction for gel pores within a hydration product of the cement body using (i) water content of the cement body attributed to each phase of reacted water and (ii) specific volumes of clinker components and reacted water phases.

18. The method of claim 1, wherein the stress is determined as a function of time.

19. The method of claim 1, wherein calculating pore pressure for the cement body comprises calculating pore pressure at a plurality of positions within the cement body.

20. The method of claim 1, wherein calculating pore pressure for the cement body comprises using permeability of the cement body.

21. The method of claim 20, wherein calculating the pore pressure of the cement body comprises using at least one of:
(i) weight of a fluid column applied to the cement body, and
(ii) self-weight of the cement body.

22. The method of claim 1, wherein the cement body comprises a cement composition and determining the failure criteria associated with the cement body comprises performing failure experiments on the cement composition to measure the failure criteria.

23. A processing system for designing a cementing operation for a cement body within a wellbore, the system comprising:
a processor; and
a memory storing instructions executable by the processor to perform processes that include:
(i) determine a stress for the cement body within the wellbore by simulating hydration of the cement body using a plurality of cementing operation parameters and a plurality of wellbore conditions, wherein simulating hydration of the cement body comprises calculating pore pressure for the cement body and accounting for changes in pore pressure associated with chemical shrinkage of the cement body; and
(ii) design a cementing operation using the stress for the cement body and the plurality of cementing operation parameters.

24. The system of claim 23, wherein the cement body is a cement sheath emplaced between casing and a formation.

25. A method of performing a cementing operation for a cement sheath emplaced between casing and a formation within a wellbore, the method comprising:
determining a stress for the cement sheath within the wellbore by simulating hydration of the cement sheath from a time of placement to a time of set using a plurality of cementing operation parameters and a plurality of wellbore conditions, wherein simulating hydration of the cement body comprises calculating pore pressure for the cement sheath and accounting for changes in pore pressure associated with chemical shrinkage of the cement sheath;
designing a cementing operation using the stress for the cement sheath and the plurality of cementing operation parameters; and
performing the cementing operation.

26. The method of claim 25, wherein calculating pore pressure for the cement sheath comprises calculating pore pressure at a plurality of positions within the cement sheath.

27. The method of claim 25, wherein calculating pore pressure for the cement sheath comprises using permeability of the cement sheath.

28. The method of claim 25, wherein determining the stress for the cement sheath comprises simulating changes in wellbore conditions acting upon the cement sheath.

29. The method of claim 28, wherein determining the stress for the cement sheath within the wellbore comprises: (i) determining an initial state of stress for the cement sheath by simulating hydration of the cement sheath, (ii) determining changes in stress caused by changing wellbore conditions by simulating changes in wellbore conditions acting upon the cement sheath, and (iii) determining the stress for the cement sheath using the initial state of stress and the changes in stress caused by changing wellbore conditions.
